(19) United States
(12) Patent Application Publication
(10) Pub. No.: US 2013/0195246 A1
(43) Pub. Date: Aug. 1, 2013

(54) TARGET STRUCTURE AND RADIATION GENERATING APPARATUS

(71) Applicant: Canon Kabushiki Kaisha, Tokyo (JP)

(72) Inventors: Miki Tamura, Kawasaki-shi (JP); Yasue Sato, Machida-shi (JP); Koji Yamazaki, Ayase-shi (JP)

(73) Assignee: CANON KABUSHIKI KAISHA, Tokyo (JP)

(21) Appl. No.: 13/751,965

(22) Filed: Jan. 28, 2013

(30) Foreign Application Priority Data
Jan. 31, 2012 (JP) 2012-018561

(51) Int. Cl. H01J 35/08; G01N 23/04

(52) U.S. Cl. CPC H01J 35/08; G01N 23/04
USPC 378/62; 378/143; 378/121

(57) ABSTRACT

A radiation-transmissive type target structure includes a target layer formed on a substrate. The target layer has a thickness equal to or less than 20 μm, and is configured to generate radiation in response to irradiation of electrons. A surface of the target layer is formed with projecting portions and depressed portions, the depressed portions have a depth of at least half the thickness of the target layer. Advantageously, separation of the target layer at an interface between the substrate and the target layer is substantially prevented. A radiation generating apparatus and a radiography system equipped with the target structure are also disclosed.

### BACKGROUND OF THE INVENTION

1. Field of the Invention

The present invention relates to a target structure for a radiation generating apparatus applicable to X-ray photography in the fields of medical imaging or non-destructive testing. The present invention also relates to a radiation generating apparatus and a radiography system equipped with the target structure.

2. Description of the Related Art

A radiation generating apparatus accelerates electrons emitted from an electron emitting source and irradiates a target structure to generate radiation. The target structure may include either a reflective target configured to extract radiation reflected from a target surface, or a transmissive target configured to extract radiation transmitting through the target structure. In both cases, when an electron beam emitted from the electron emitting source enters the target, a large part of incident energy is converted into heat. For this reason, the temperature of the target structure rises to a high temperature.

In the case of the transmissive target, a thin film target layer is used for reducing absorbance of the generated radiation. Therefore, when the electron beam irradiates the target, not only the portion near the surface of the target layer, but also the portion near an interface between the target layer and a supporting substrate undergo an increase in temperature. Excessive temperature increases may cause thermal stress in the target layer and the supporting substrate due to the difference in coefficient of thermal expansion therebetween, and hence separation of the target layer at the interface between the target layer and the supporting substrate may result. When separation of the target layer occurs, a radiation dose is lowered, and reliability is remarkably lowered. As a countermeasure, Japanese Patent Application Laid-Open No. 2000-306533 discloses a technology to prevent the separation of the target layer from its substrate by forming an intermediate thin film such as copper, chrome, iron, nickel, and the like between the target layer formed of tungsten and an X-ray permeable window panel formed of beryllium.

In the case of the reflective target, when the electron beam irradiates the target, projections and depressions are formed on the target surface due to thermal stress. Specifically, at the time of irradiation, part of the emitted radiation is absorbed by the projecting portions on the target surface, and the radiation dose is reduced. U.S. Pat. No. 7,079,625 discloses a technology to avoid deformation of the target surface due to heat by forming micro-slits having a depth of 30 μm to 100 μm inclusive on the target surface.

As described above, even if the intermediate thin film is formed between the target layer and the supporting substrate, when there is a significant difference among the coefficients of thermal expansion of respective materials of the target layer, the supporting substrate, and the intermediate thin film, separation of the target layer or the intermediate thin film may occur due to excessive and repetitive high temperature increases. There is also a problem that when an attempt is made to equalize the coefficients of the thermal expansion of the materials of the target layer, the supporting substrate, and the intermediate thin film, combinations of the materials to be used are significantly limited. Therefore, a technology for preventing the separation of the target layer without limiting the combinations of materials to be used is demanded.

Although the technology disclosed in U.S. Pat. No. 7,079,625 is intended to inhibit the deformation of the target layer caused by a large thickness of the target layer, this technology is not applicable for the transmissive target.

### SUMMARY OF THE INVENTION

The present invention provides a radiation transmissive target structure having a target layer and a substrate supporting the target layer, in which separation of the target layer at an interface between the substrate and the target layer is restrained, and a radiation generating apparatus and a radiography system having such a target structure.

The various embodiments of the present invention are directed to a radiation-transmissive type target structure including: a target layer formed on a substrate, the target layer being configured to generate radiation in response to irradiation of electrons and having a thickness equal to or less than 20 μm, wherein a surface of the target layer is formed with projecting portions and depressed portions, depressed portions have a thickness of at least half the thickness of the target layer.

According to the invention, by virtue of the depressed portions on the target layer, thermal stress generated by the difference in coefficient of thermal expansion between the target layer and the substrate is reduced. Therefore, even when an intermediate layer is not provided between the substrate and the target layer, separation of the target layer at an interface between the substrate and the target layer may be prevented. Therefore, reduction of a radiation dose may also be restrained also in a long time driving and a radiation-transmissive type target superior in reliability is provided. In addition, by applying the target structure disclosed herein, a radiation generating apparatus and a radiography system superior in reliability are provided.

Further features of the present invention will become apparent from the following description of exemplary embodiments.

### BRIEF DESCRIPTION OF THE DRAWINGS

FIGS. 1A to 1D are schematic drawings illustrating an example of a target structure.

FIGS. 2A to 2D are schematic drawings illustrating another example of the target structure.

FIGS. 3A and 3B are schematic drawings of the target structure including an intermediate layer formed between a substrate and a target layer.

FIG. 4 is a schematic drawing of the target structure in which the target layer is covered with a protective layer.

FIG. 5 is a schematic cross-sectional view of a radiation generating apparatus including the target structure of the invention.

FIG. 6 is a diagram illustrating a configuration of a radiography system using the radiation generating apparatus of the invention.

### DESCRIPTION OF THE EMBODIMENTS

Referring now to the drawings, an embodiment of the invention will be described. Examples of radiation used in the invention include an X-ray.

### First Embodiment

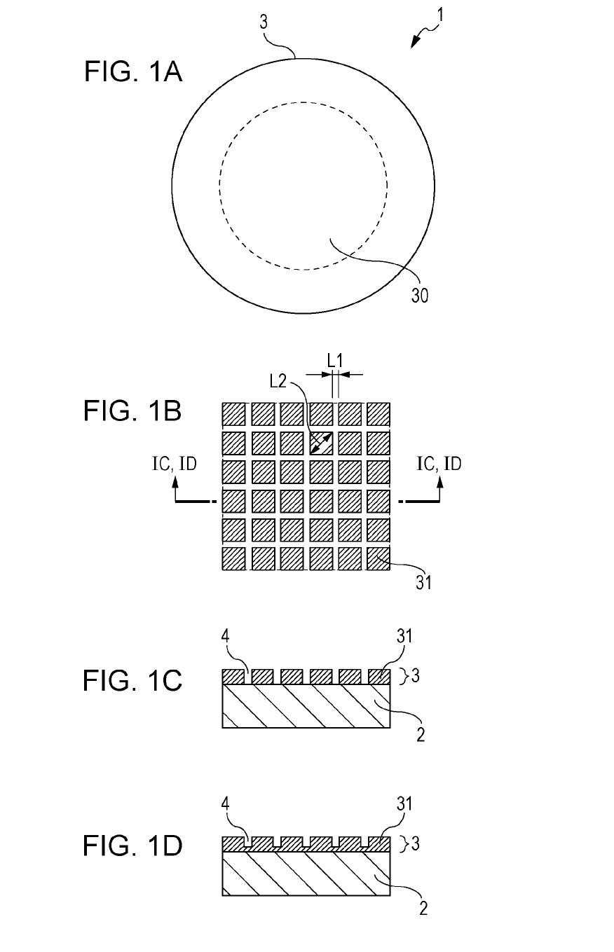

FIGS. 1A to 1D are schematic drawings illustrating a transmissive target structure of a first embodiment. FIG. 1A is a top view, FIG. 1B is an enlarged drawing of an area 30 in FIG. 1A, and FIGS. 1C and 1D are cross-sectional views taken along the line IC, ID-IC, ID in FIG. 1B.

A target structure 1 includes a substrate 2 and a target layer 3 formed on a surface of the substrate 2. When an electron beam enters the target layer 3, radiation is generated, and part of the generated radiation transmits through the substrate 2 and is emitted to the opposite side of the target layer 3.

Materials which constitute the substrate 2 can be those having strength enough for supporting the target layer 3, absorbing little radiation generated in the target layer 3, and having a high thermal conductivity so as to be capable of releasing heat generated in the target layer 3 quickly. For example, diamond, silicon carbide, silicon nitride, aluminum nitride may be used. The thickness of the substrate 2 can be 0.1 mm to 10 mm in order to satisfy the requirements for the substrate 2.

Materials which constitute the target layer 3 can be those having a high fusing point and high radiation generating efficiency. For example, tungsten, tantalum, molybdenum, or alloy containing these metals may be used. The thickness of the target layer 3 is preferably 20 μm or lower in order to reduce the amount of absorption of the generated radiation when passing through the target layer 3 and thicknesses from 2 μm to 20 μm inclusive are adequate.

In the area 30 in FIG. 1A, the surface of the target layer 3 is uneven by forming with projections and depressions. FIG. 1C illustrates an example in which the target layer 3 is divided into a plurality of parts by depressed portions 4 of the projections and depressions on the surface. FIG. 1D illustrates an example in which the target layer 3 is not completely divided by the depressed portions 4 of the projections and depressions on the surface. The larger the depth of the depressed portions 4, the more effect of reduction in a thermal stress is expected. Therefore, the depth of the depressed portions 4 can be at least half the thickness of the target layer 3. Preferably, the depth of the depressed portions is ⅔ or larger the thickness of the target layer 3. Here, the area 30 in FIG. 1A has to be an area including a range irradiated with the electron beam, and may be the entire area of the surface of the target layer 3.

If a width L1 of the depressed portions 4 is too small, the effect of the reduction in thermal stress is small. In addition, it becomes difficult to manufacture the protrusions or projection portions. If the width L1 is too wide, a reduction in radiation dose or deterioration of image quality may result. Therefore, an average of the width L1 is preferably 0.1 μm to 20 μm. If a width L2 of projecting portions 31 is too small, it becomes difficult to manufacture the projecting portions 31. In contrast, if the width L2 is too large, the effect of the reduction in thermal stress becomes too small. Therefore, an average of the width L2 is preferably within 1 μm to 100 μm.

With the depressed portions 4 provided on the target layer 3, the thermal stress generated by the difference in the coefficients of thermal expansion between the target layer 3 and the substrate 2 is reduced. In this manner, separation of the target layer 3 at an interface between the substrate 2 and the target layer 3 may be substantially prevented. Therefore, radiation dose may be maintained at an optimal level even if the target structure is used under high temperature in a long time driving.

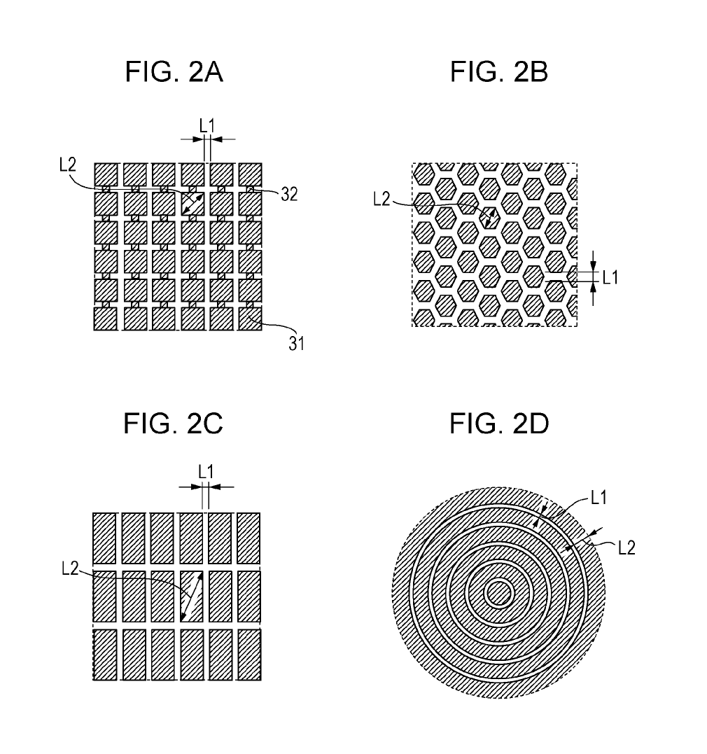

Shapes of the depressed portions 4 and the projecting portions 31 only have to satisfy the above-described conditions of the widths L1 and L2, and are not limited to the shapes in FIG. 1. FIGS. 2A to 2D illustrate examples of other shapes of the target layer 3 applicable to the invention. The material which constitutes the target layer 3 and the thickness of the target layer 3 are the same as those in FIGS. 1A to 1D.

In the same manner as FIGS. 1B to 1D, FIG. 2A illustrates the target layer 3 having the depressed portions 4 arranged in a two-dimensional matrix pattern and part of the projecting portions 31 of the target layer 3 divided by the depressed portions 4 are coupled by coupling portions 32. In a case where the substrate 2 is an insulative substrate such as diamond, silicon nitride, or aluminum nitride, conduction of the target layer 3 is achieved by coupling part of the projecting portions 31 to each other.

FIG. 2B illustrates the target layer 3 divided by the depressed portions 4, in which the projecting portions 31 have hexagonal shapes. FIG. 2C illustrates the target layer 3 divided by the depressed portions 4, in which the projecting portions 31 have rectangular shapes. FIG. 2D illustrates the target layer 3 divided by the depressed portions 4, in which the projecting portions 31 have concentric circle shapes. In FIG. 2B to FIG. 2D, in the same manner as in FIG. 2A, part of the projecting portions 31 of the target layer 3 divided by the depressed portions 4 may be coupled by the coupling portions 32 not illustrated.

In FIG. 2A to FIG. 2D, in the same manner as in FIG. 1D, the target layer 3 does not have to be divided completely by the depressed portions 4. The shape of the depressed portions 4 may be a combination of any of FIG. 2A to FIG. 2D.

Examples of a method of forming the target layer 3 on the substrate 2 include film formation methods such as a sputtering method, an evaporation method, an ion plating method, a CVD (chemical vapor deposition) method. As a method of forming the depressed portions 4, a method of forming a film with a mask covering on portions where the depressed portions 4 are formed arranged on the substrate 2 when forming the film of the target layer 3 may be employed. Alternatively, a method of forming the film of the target layer 3 on the substrate 2, and then masking portions other than the portions where the depressed portions 4 are formed with photoresist, and removing the target layer 3 of the portions where the depressed portions 4 are formed by etching may be employed. Moreover, the well known methods of trench etching AND laser ablation may be adopted to create the above describe projecting (protruding) portions 31 and depressed portions 4. In the case of using trench etching technology, the depressed portions 4 may also be referred to as “trench structures”.

According to the first embodiment, a range of options of the materials of the substrate 2 and the target layer 3 may be increased.

### Second Embodiment

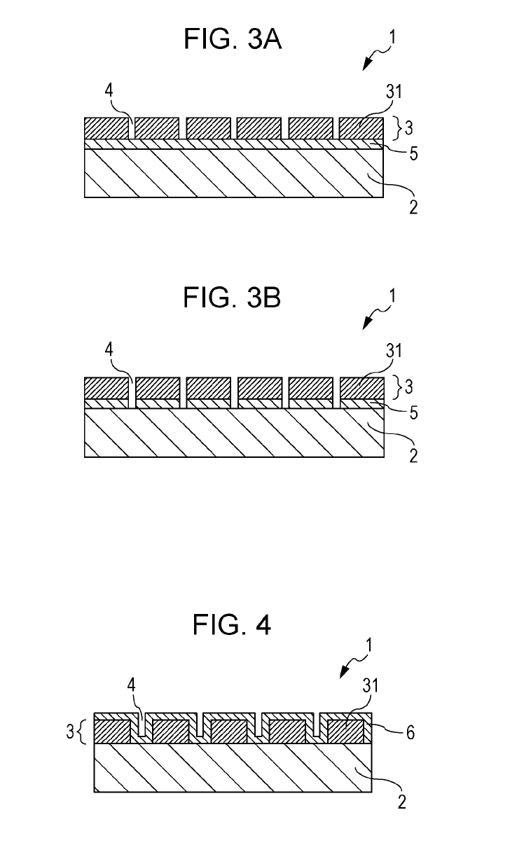

FIGS. 3A and 3B are cross-sectional views of a radiation-transmissive type target structure of a second embodiment. In the second embodiment, an intermediate layer 5 is provided between the substrate 2 and the target layer 3, and other configuration may be the same as those in the first embodiment.

In FIGS. 3A and 3B, the intermediate layer 5 has a function to further improve adhesiveness between the substrate 2 and the target layer 3. The material which constitutes the intermediate layer 5 can be a material having good adhesiveness with respect to the material which constitutes the substrate 2 and the target layer 3. Examples of such materials include titanium, chrome, vanadium, tantalum, or alloy or compound containing such metals. The intermediate layer 5 may have a function to allow heat generated in the target layer 3 to be conducted to the substrate 2.

The thickness of the intermediate layer 5 can be a thickness which ensures the adhesiveness between the substrate 2 and the target layer 3 and reduces the absorption of the radiation generated in the target layer 3, and preferably is 0.01 μm to 0.1 μm.

In the second embodiment, the target layer 3 is provided with the depressed portions 4 in the same manner as in the first embodiment. FIG. 3A illustrates an example in which the target layer 3 is divided into a plurality of parts by the depressed portions 4, and the intermediate layer 5 is not divided. FIG. 3B illustrates an example in which the target layer 3 is divided into a plurality of parts by the depressed portions 4, the intermediate layer 5 is also provided with projections and depressions on the surface thereof as well, areas positioned under the projecting portions 31 of the target layer 3 are formed as depressed portions, and the intermediate layer 5 is divided into a plurality of part by the depressed portions.

In the same manner as FIG. 1D, the target layer 3 does not have to be divided completely by the depressed portions 4. The intermediate layer 5 does not have to be divided into a plurality of parts even when the target layer 3 is divided into a plurality of parts by the depressed portions 4.

Examples of a method of forming the intermediate layer 5 and the target layer 3 on the substrate 2 include film formation methods such as the spattering method, the evaporation method, the ion plating method, the CVD method. As a method of forming the depressed portions, a method of forming a film with a mask covering on portions where the depressed portions are formed arranged on the substrate at the time of film formation may be employed. At this time, the depressed portions 4 are formed only in the target layer 3 as illustrated in FIG. 3A by arranging the mask when forming the film of the target layer 3. Also, the depressed portions are formed in the target layer 3 and the intermediate layer 5 as illustrated in FIG. 3B by arranging the mask when forming the film of the intermediate layer 5 and the target layer 3. Alternatively, a method of forming the film of the intermediate layer 5 and the target layer 3 on the substrate 2, and then masking portions other than the portions where the depressed portions are formed with the photoresist, and removing the target layer 3, or the target layer 3 and the intermediate layer 5 of the portions where the depressed portions are formed by etching may be employed.

As described thus far, according to the second embodiment, since the intermediate layer 5 which improves the adhesiveness is formed between the substrate 2 and the target layer 3, the adhesiveness between the substrate 2 and the target layer 3 is further enhanced.

### Third Embodiment

In a third embodiment, a protective layer 6 covering the target layer 3 is provided without covering the depressed portions 4 of the target layer 3, and other configurations are the same as those in the first embodiment.

In FIG. 4, the protective layer 6 is configured to restrain separation or lifting of the target layer 3, and the material of the protective layer 6 can be those having good adhesiveness with respect to the materials of the substrate 2 and the target layer 3, and having a coefficient of thermal expansion close thereto. In addition, a material having relatively small atomic numbers which have a large electron penetration depth can be sued for reducing the absorption of the electron beam in the protective layer 6. Examples of options of such materials include titanium, nickel, zirconium, chrome, niobium, silicon, or alloy or compound containing such metals. The protective layer 6 can also be formed continuously so as to cover the target layer 3 and the depressed portions 4, and preferably has a thickness of 1 μm to 20 μm.

The same method as in the first embodiment may be used as a method of forming the target layer 3 on the substrate 2 and forming the depressed portions 4 on the target layer 3. Examples of a method of forming the protective layer 6 on the target layer 3 include film formation methods such as the spattering method, the evaporation method, the ion plating method, the CVD method.

As described thus far, according to the third embodiment, since the protective layer 6 is formed so as to cover the target layer 3, the adhesiveness between the substrate 2 and the target layer 3 is further enhanced.

### Fourth Embodiment

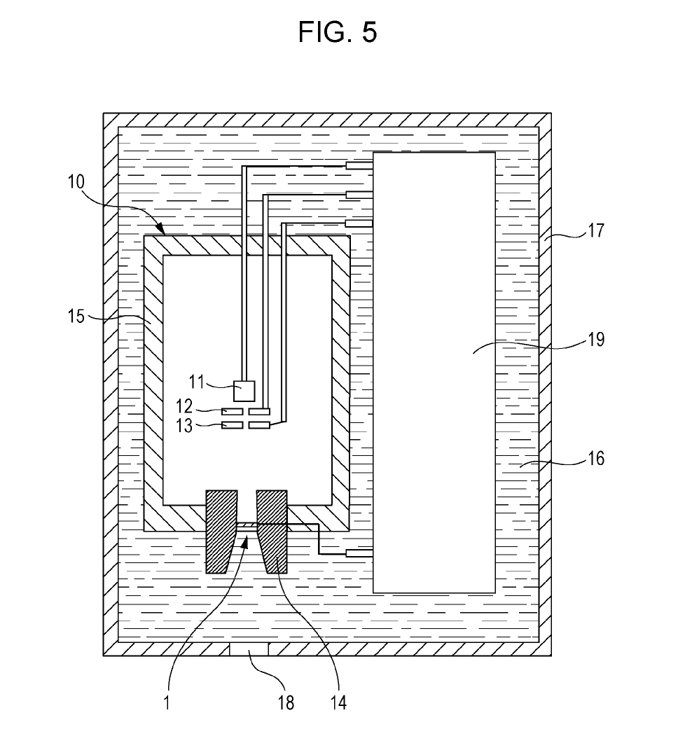

Subsequently, a radiation generating apparatus provided with the radiation-transmissive type target structure of the invention will be described with reference to FIG. 5.

A radiation generating tube 10 includes a vacuum container 15, an electron emitting source 11, the target structure 1, and a radiation shielding member 14. Any of the target structures described in the first to the third embodiments may be applied to the target structure 1.

A remaining space in the interior of a storage container 17 accommodating the radiation generating tube 10 therein is filled with an insulative medium 16. The storage container 17 may be provided with a high-voltage circuit substrate 19 composed of a circuit substrate and an insulating transformer or the like, not illustrated, as in the fourth embodiment in the interior thereof. When the high-voltage circuit substrate 19 is provided, a voltage signal is applied, for example, from the high-voltage circuit substrate 19 to the radiation generating tube 10, so that generation of the radiation may be controlled.

The storage container 17 can be a container having a sufficient strength as a container, and being superior in heat releasing property, and metallic material such as brass, iron, stainless and the like can be used.

The insulative medium 16 only have to have electrical insulating properties, and electrical insulation oil having roles as an insulating medium and a cooling medium for the radiation generating tube 10 can be used.

The storage container 17 is provided with a radiation transmitting window 18 for extracting the radiation to the outside of the storage container. The radiation released from the radiation generating tube 10 is released to the outside through the radiation transmitting window 18.

The vacuum container 15 is configured to maintain the interior of the radiation generating tube 10 to be under vacuum, and examples of materials of the vacuum container 15 include glass and ceramics material. The degree of vacuum in the interior of the vacuum container 15 can be on the order of 10-4 Pa to 10-8 Pa. The vacuum container 15 has an opening, and the radiation shielding member 14 is bonded to the opening. The radiation shielding member 14 has a passage communicating with the opening of the vacuum container 15, and the vacuum container 15 is sealed by the target structure 1 bonded to the passage.

The electron emitting source 11 is arranged in the interior of the vacuum container 15 so as to face the opening of the vacuum container 15. Examples of the electron emitting source 11 include a hot cathode or a cold cathode. An extraction electrode 12 is arranged in the vicinity of the electron emitting source 11, and electrons released by an electric field generated by the extraction electrode 12 are converged by a lens electrode 13 and enter the target structure 1 to generate the radiation. At this time, a voltage Va applied between the electron emitting source 11 and the target layer of the target structure 1, although varying depending on the application of the radiation, is on the order of 40 kV to 150 kV.

The electrons released from the electron emitting source 11 pass through the passage of the radiation shielding member 14 which communicates the opening of the vacuum container 15 and is directed to the target layer. At this time, unnecessary radiation scattered toward the electron emitting source of the target layer is blocked by the radiation shielding member 14. The radiation transmitting through the target layer passes through the passage of the radiation shielding member 14 which communicates the opening of the vacuum container 15 and unnecessary radiation is blocked by the radiation shielding member 14.

The material which constitutes the radiation shielding member 14 can be a material having high radiation absorption and high thermal conductivity. For example, metallic materials such as tungsten or tantalum may be used. In order to block unnecessary radiation, the thickness of the radiation shielding member 14 can be 3 mm or more.

The shape of the radiation shielding member 14 may be such that the opening area of the passage of the radiation increases gradually from the target structure 1 toward the storage container 17 as illustrated in FIG. 5 so as to control an angle of radiation.

### Fifth Embodiment

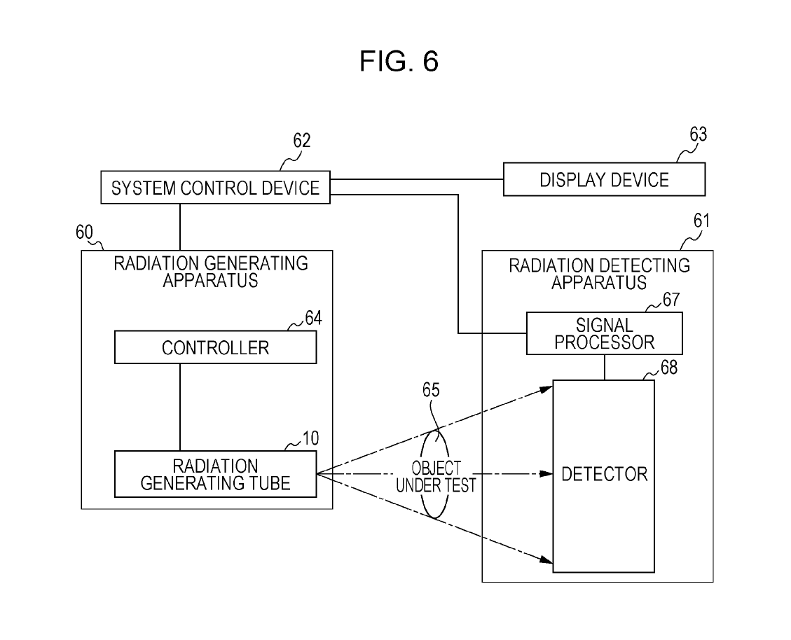

Subsequently, a radiography system using the radiation generating apparatus of the fourth embodiment will be described. FIG. 6 is a diagram illustrating a configuration of the radiography system of the fifth embodiment.

A system control device 62 controls a radiation generating apparatus 60 and a radiation detecting apparatus 61 in cooperation with each other. A controller 64 outputs various control signals to the radiation generating tube 10 under the control of the system control device 62. The state of release of the radiation released from the radiation generating apparatus 60 is controlled by the control signal. The radiation released from the radiation generating apparatus 60 passes through an object under test 65 and is detected by a detector 68. The detector 68 converts the detected radiation into an image signal and outputs the converted image signal to a signal processor 67. The signal processor 67 applies a predetermined signal processing on the image signal under the control of the system control device 62, and outputs the processed image signal to the system control device 62. The system control device 62 outputs a display signal for displaying an image on a display device 63 to the display device 63 on the basis of the processed image signal. The display device 63 displays the image on the basis of the display signal on a screen as a photographed image of the object under test 65.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-018561 filed Jan. 31, 2012, which is hereby incorporated by reference herein in its entirety.

What is claimed is:

1. A radiation-transmissive type target structure comprising:
a target layer formed on a substrate, the target layer being configured to generate radiation in response to irradiation of electrons and having a thickness equal to or less than 20 μm,
wherein a surface of the target layer is formed with projecting portions and depressed portions, and
wherein the depressed portions have a depth of at least half the thickness of the target layer.

2. The radiation-transmissive type target structure according to claim 1, wherein the target layer is divided into a plurality of parts by the depressed portions.

3. The radiation-transmissive type target structure according to claim 1, wherein the depressed portions have an average width from 0.1 μm to 20 μm.

4. The radiation-transmissive type target structure according to claim 1, wherein the projecting portions have an average width from 1 μm to 100 μm.

5. The radiation-transmissive type target structure according to claim 1, wherein an intermediate layer is formed between the substrate and the target layer.

6. The radiation-transmissive type target structure according to claim 1, wherein a protective layer is formed so as not to cover the depressed portions and so as to cover the target layer.

7. A radiation generating apparatus comprising:
an electron emitting source configured to emit an electron beam; and
a radiation-transmissive type target structure,
the target structure including: a target layer formed on a substrate, the target layer being configured to generate radiation in response to irradiation of electrons from the electron beam and having a thickness equal to or less than 20 μm,
wherein a surface of the target layer is formed with projecting portions and depressed portions, and
wherein the depressed portions have a depth of at least half the thickness of the target layer.

8. A radiography system comprising:
a radiation generating apparatus configured to generate radiation;
a radiation detecting apparatus configured to detect the radiation emitted from the radiation generating apparatus and passed through an object under test; and
a control device configured to control the radiation generating apparatus and the radiation detecting apparatus,
the radiation generating apparatus comprising:
an electron emitting source configured to emit an electron beam, and
a radiation-transmissive type target structure having: a target layer formed on a substrate, the target layer being configured to generate the radiation in response to irradiation of electrons from the electron beam and having a thickness equal or less than 20 μm,
wherein a surface of the target layer is formed with projecting portions and depressed portions, and
wherein the depressed portions have a depth of at least half the thickness of the target layer.
